(19) United States
(12) Patent Application Publication
(10) Pub. No.: US 2025/0148936 A1
(43) Pub. Date: May 8, 2025

(54) Labels with Adhesive Patch Patterns Optimized for Printer Applications

(71) Applicant: Iconex LLC, Duluth, GA (US)

(72) Inventors: James Kirby Price, Morristown, TN (US); Michael Bejon Sethna, Jefferson City, TN (US); John Raymond Fitzgerald, Clover, SC (US)

(21) Appl. No.: 18/504,959

(22) Filed: Nov. 8, 2023

(51) Int. Cl. G09F 3/02; G09F 3/10

(52) U.S. Cl. CPC G09F 3/02; G09F 3/10; G09F 2003/0201; G09F 2003/0208; G09F 2003/0248

(57) ABSTRACT

Linerless labels with adhesive patches arranged in optimal adhesive patch patterns are provided. The adhesive patch patterns mitigate adhesive buildup on components of a printer when a roll of linerless labels is fed through a printer by minimizing the adhesive coverage area on the backside of the linerless labels without altering the adhesive bonding characteristics of the individual linerless labels dispensed from the printer.

### BACKGROUND

Labels are used for a variety of purposes across multiple industries. Furthermore, labels have a variety of capabilities based on their intended applications. Many label capabilities are dependent upon a variety of adhesive-based factors, such as adhesive type, adhesive pattern, adhesive patch shapes, adhesive flood coat, mixtures of adhesives, and adhesive activation mechanism (e.g., pressure, heat, etc.). Capabilities that require a high tack are often achieved through using an aggressive adhesive.

A label with an aggressive adhesive sticks to or accumulates on components of a printer as a roll of labels are imaged/printed by the printer. That is, labels with aggressive adhesives cause printer jams or printer malfunctions with greater regularity than do labels with less aggressive adhesives.

### SUMMARY

In various embodiments, linerless labels with adhesive patch patterns, which are optimized to reduce adhesive buildup on printer components, and a method for manufacturing the labels with the patch patterns are provided. In an embodiment, a linerless label is provided. The linerless label includes a substrate, the backside of the substrate includes an adhesive patch disposed on the backside in a pattern.

In an embodiment, the pattern includes four adhesive patches. The four adhesive patches do not intersect with one another, and each adhesive patch is offset from two sides of the label. First and second adhesive patches are of a first shape while third and fourth adhesive patches are of a second shape. The first adhesive patch is diagonal to the second adhesive patch and the third adhesive patch is diagonal to the fourth adhesive patch. The first adhesive patch is situated above the third adhesive patch and the fourth adhesive patch is situated above the second adhesive patch.

An adhesive coverage area associated with the pattern is minimized to avoid and to mitigate contact with printer components. However, the minimized adhesive coverage area does not decrease the adhesive bonding characteristics of the linerless labels.

### BRIEF DESCRIPTION OF THE DRAWINGS

FIG. 1 is a diagram of a linerless label with an adhesive patch pattern optimized for printer applications, according to an example embodiment.

FIG. 2 is a diagram of another linerless label in a roll of labels, each label with an adhesive patch pattern optimized for printer applications, according to an example embodiment.

FIG. 3 is a diagram of still another linerless label in a roll of labels, each label with an adhesive patch pattern optimized for printer applications, according to an example embodiment.

FIG. 4 is a diagram of yet another linerless label in a roll of labels, each label with an adhesive patch pattern optimized for printer applications, according to an example embodiment.

FIG. 5 is a diagram of a linerless label in a roll of labels, each label with an adhesive patch pattern optimized for printer applications, according to an example embodiment.

FIG. 6 is a diagram of another linerless label in a roll of labels, each label with an adhesive patch pattern optimized for printer applications, according to an example embodiment.

FIG. 7 is a diagram of a linerless label in a roll of labels, each label with an adhesive patch pattern optimized for printer applications, according to an example embodiment.

FIG. 8 is a diagram of yet another linerless label in a roll of labels, each label with an adhesive patch pattern optimized for printer applications, according to an example embodiment.

FIG. 9 is a diagram of a linerless label in a roll of labels, each label with an adhesive patch pattern optimized for printer applications, according to an example embodiment.

FIG. 10 is a diagram of a method for manufacturing a roll of linerless labels, each label with an adhesive patch pattern optimized for printer applications, according to an example embodiment.

### DETAILED DESCRIPTION

As stated above, aggressive adhesives present difficulties for printer-based label applications because the adhesive sticks to or accumulates on components of the printer as a roll of labels is fed through the printer. Many retailers print labels for orders or transactions from printers. The labels are then adhered to the packaging of the orders, when the packaging necessitates use of a label with an aggressive adhesive, the retailer has to produce a solution. Presently, the options available to a retailer is either to request changes in the packaging material and/or request the label stock be changed to a more expensive and stiffer paper. Both options are likely to increase the retailer's costs.

These issues are solved with the linerless labels provided herein. The linerless labels include optimized adhesive patches disposed in optimized patterns on the backside of the linerless labels. The adhesive patch patterns permit usage of high tack and aggressive adhesives on the labels while mitigating printer adhesive buildup, jams, and other printer malfunctions caused by adhesive buildup on the printer components. The shapes, sizes, orientations, and location of the adhesive patch patterns on the backside of the linerless labels ensure minimal contact with printer components when a roll of the labels are fed through the printer. Furthermore, the shapes, sizes, orientations, and location of the adhesive patch patterns on the backside of the linerless labels do not decrease the stickiness nor decrease adhesive bonding capabilities of the linerless labels after the linerless labels are dispensed from the printer and adhered to objects, packages, and/or surfaces. The linerless labels with the adhesive patches in the optimized patterns permit aggressive adhesives to be used in rolls of linerless labels without the rolls causing adverse printer malfunctions.

In an embodiment, the labels presented herein and below with the adhesive patches disposed on the backside of the labels in the optimized adhesive patterns are linerless labels.

In an embodiment, a front side of the label substrate associated with the linerless labels includes a thermally activated and sensitive image coating. A thermal printer selectively applies heat to the coating on the front side to image custom indicia on the front side of each linerless label. In an embodiment, the thermally activated and sensitive image coating further includes a release coating applied atop the thermally activated and sensitive image coating, which permits a sheet of the linerless labels to be wound into a roll, the roll fed to the thermal printer, the roll unwound by the thermal printer, the front sides of the labels imaged/printed by the thermal printer, and individual printed/imaged labels cut and dispensed by the thermal printer.

In an embodiment, the label substrate is a paper-based material or paper. In an embodiment, the label substrate is a film.

As used herein, the phrases “optimized adhesive patches” and/or “optimized adhesive patch patterns” can be used interchangeably and synonymously herein and below. This is intended to mean that the size, shape, placement, orientation, location, and coverage area of the adhesive associated with a given patch and pattern are designed to minimize adhesive buildup on components of printers when a roll of the labels is fed through a printer without decreasing the adhesive bonding characteristics of the labels dispensed from the printers.

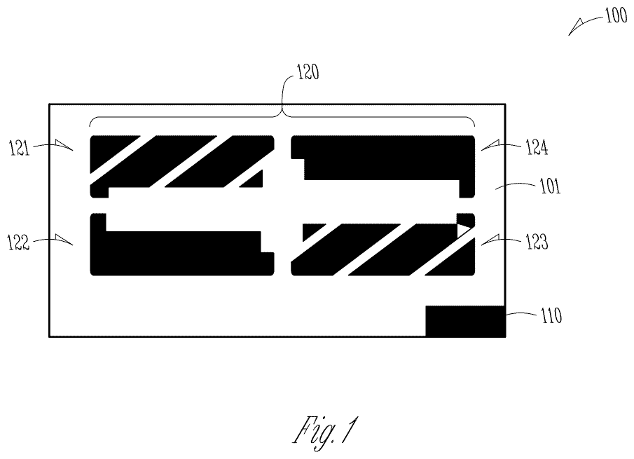

FIG. 1 is a diagram of a linerless label 100 with an adhesive patch pattern 120 optimized for printer applications, according to an example embodiment. A backside 101 of a label substrate for the label 100 is illustrated in FIG. 1.

The darkened areas (except for 110) represent the adhesive disposed on the backside 101 in the illustrated pattern 120. A sense mark 110 is printed or imaged in a bottom corner of the backside 101. The sense mark 110 delineates the label 100 from other labels 100 in a roll. The sense marks 110 are read by a printer to identify each individual label 100 within the roll when the roll is fed into the printer for imaging/printing the labels 100 from the roll.

The coverage area of the adhesive patch defined by the adhesive pattern 120 is less than a remaining area of the backside 101 defined by the white areas and the sense mark 110 in FIG. 1. In an embodiment, the adhesive coverage area of the adhesive patch is approximately 30.10% of a total area associated with the backside 101 of the label substrate.

The adhesive pattern 120 includes a first adhesive patch 121, a second adhesive patch 123, a third adhesive patch 122, and a fourth adhesive patch 124. None of the adhesive patches 121-124 intersect with one another. The first adhesive patch 121 and the second adhesive patch 123 are of a same first shape. The third adhesive patch 122 and the fourth adhesive patch 124 are of a same second shape.

The first adhesive patch 121 is diagonally situated on the backside 101 relative to the second adhesive patch 123. Similarly, the third adhesive patch 122 is diagonally situated on the backside 101 relative to the fourth adhesive patch 124. The first adhesive patch 121 is situated above the third adhesive patch 122 and the fourth adhesive patch 124 is situated above the second adhesive patch 123. The horizontal and vertical orientation of the second adhesive patch 123 is flipped/reversed relative to the horizontal and vertical orientation of the first adhesive patch 121. Similarly, the horizontal and vertical orientation of the fourth adhesive patch 124 is flipped/reversed relative to the horizontal and vertical orientation of the third adhesive patch 122.

The first shape associated with the first adhesive patch 121 and the second adhesive patch 123 is similar to but not identical to the second shape associated with the third adhesive patch 122 and the fourth adhesive patch 124. Notably, the first shape include diagonal cutout lines which are devoid of adhesive, and the height of the first shape is larger than the height of the second shape. Both shapes include a rectangular portion and two extending rectangular bars. The orientation of the shapes are such that the extending rectangular bars of each adhesive patch are pointing at adjacent adhesive patch's extending rectangular bars.

In an embodiment, the first shape associated with the first adhesive patch 121 and the second adhesive patch 123 include three diagonal bars that are cutout and devoid of any adhesive. I an embodiment, a first offset between a top side of the label 100 and a top of the first adhesive patch 121 and the fourth adhesive patch is smaller than a second offset between a bottom side of the label 100 and a bottom of the third adhesive patch 122 and the second adhesive patch 123.

In an embodiment, a plurality of labels 100 are defined within a roll of labels, each label separated by an imaged/printed sense mark 110. The roll is inserted into an infeed of a printer and fed to the printer. The printer images/prints custom indicia on each label 100, cuts each label 100 from the roll, and dispenses each label 100 for application to packaging, an object, or a surface. When the roll is fed through the printer, the coverage area of the adhesive on the backside 101 defined by the pattern 120, and the size, location, and orientations of adhesive patches 121-124 for the adhesive patch minimize adhesive contact with printer components. This minimizes adhesive buildup and printer jams/malfunctions. Furthermore, the coverage area of the adhesive on the backside defined by the pattern 120, and the size, location, and orientations of the adhesive patches 121-124 do not decrease the labels' adhesive bonding characteristics once the labels 100 are dispensed individually from the printer. In an embodiment, an aggressive adhesive is used for the adhesive patch identified by pattern 120 and adhesive patches 121-124.

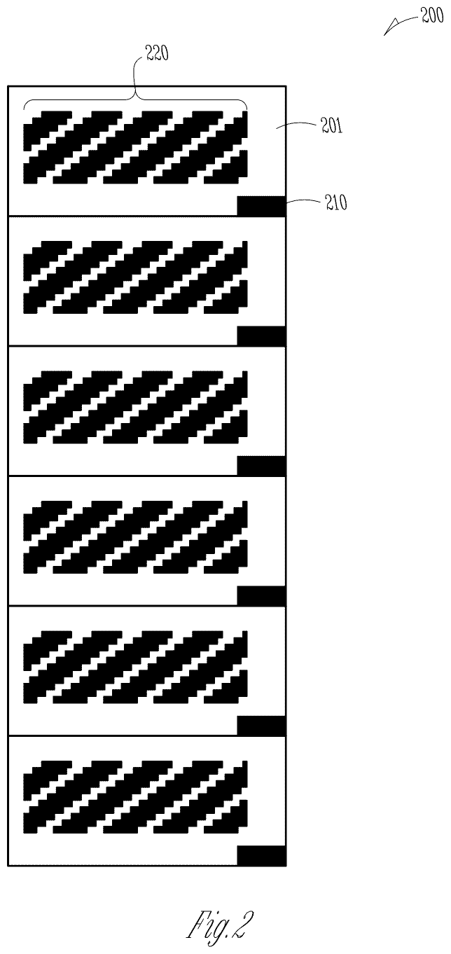

FIG. 2 is a diagram of another linerless label 200 in a roll, each label 200 includes an adhesive patch pattern 220, which is optimized for printer applications, according to an example embodiment. Again, a backside 201 for each label 200 in the roll is illustrated in FIG. 2.

The backside 201 includes an adhesive patch illustrated by the darkened areas (except not 210), which are arranged in an adhesive patch pattern 220. Each label 200 within the roll further includes a printed/imaged sense mark 210, which is read by a printer to delineate and to identify each label 220 within the roll.

The adhesive patch pattern 220 includes diagonally oriented adhesive patches, which do not intersect with one another on the backside 201 of each label 200. Between each adhesive patch is a bar shaped area, which is devoid of any adhesive. A few of the adhesive patches are of a same size while other of the adhesive patches are of varied sizes.

The coverage area, shape, size, orientation, and placement of the adhesive patches within the pattern 220 of the adhesive patch are optimized to minimize contact with printer components when the roll of the labels 200 are fed through the printer. However, the coverage area, shape, size, orientation, and placement of the adhesive patches within the pattern 220 of the adhesive patch for each dispensed label 200 from the printer maintains the adhesive bonding characteristics for the type of the adhesive used to still stick and adhered the label 200 to package materials, objects, and surfaces.

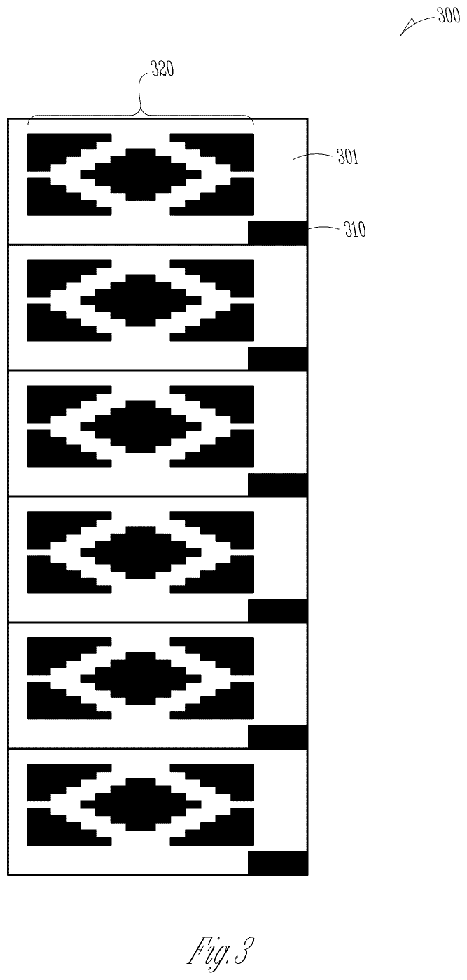

FIG. 3 is a diagram of still another linerless label 300 in a roll, each label 200 includes an adhesive patch pattern 320, which is optimized for printer applications, according to an example embodiment. A backside 301 for each label 300 in the roll is illustrated in FIG. 3.

The backside 301 includes an adhesive patch illustrated by the darkened areas (except not 310), which are arranged in an adhesive patch pattern 320. Each label 300 within the roll further includes a printed/imaged sense mark 310, which is read by a printer to delineate and to identify each label 320 within the roll.

The adhesive patch pattern 320 includes 5 adhesive patches, which do not intersect with one another on the backside 301 of each label 300. Between each adhesive patch is an area, which is devoid of any adhesive. Four of the adhesive patches are of a same size one of the adhesive patches is larger than the other four adhesive patches. The largest adhesive patch is substantially centered on the backside 301 and is in a diamond shape. The four other adhesive patches are each adjacent to a unique corner of the backside 301 and each triangular in shape. A non-adhesive area separates the sides or perimeter of the backside 301 and the four corner adhesive patches. A diamond-shaped non-adhesive area surrounds the center diamond shaped component. The diamond-shaped non-adhesive area is larger than the center diamond shaped component.

The coverage area, shape, size, orientation, and placement of the five adhesive patches within the pattern 320 of the adhesive patch are optimized to minimize contact with printer components when the roll of the labels 300 are fed through the printer. However, the coverage area, shape, size, orientation, and placement of the five adhesive patches within the pattern 320 of the adhesive patch for each dispensed label 300 from the printer maintains the adhesive bonding characteristics for the type of the adhesive used to still stick and adhered the label 300 to package materials, objects, and surfaces.

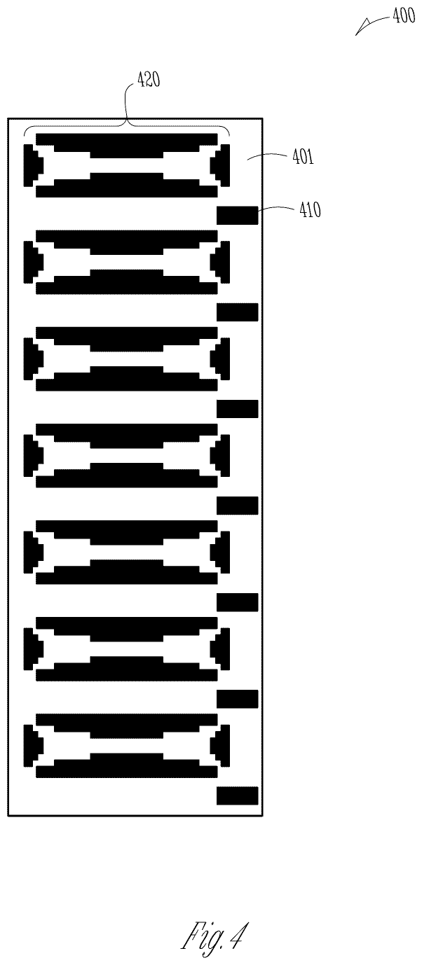

FIG. 4 is a diagram of yet another linerless label 400 in a roll, each label 400 includes an adhesive patch pattern 420, which is optimized for printer applications, according to an example embodiment. A backside 401 for each label 400 in the roll is illustrated in FIG. 4.

The backside 401 includes an adhesive patch illustrated by the darkened areas (except not 410), which are arranged in an adhesive patch pattern 420. Each label 400 within the roll further includes a printed/imaged sense mark 410, which is read by a printer to delineate and to identify each label 420 within the roll.

The adhesive patch pattern 420 includes 4 adhesive patches, which do not intersect with one another on the backside 401 of each label 400. Between each adhesive patch is an area, which is devoid of any adhesive. A first set of two of the adhesive patches is of a same first size while a second set of two of the adhesive patches is of a same second size; the second size is larger than the first size. The first set of adhesive patches is adjacent to a right or left side of the label 400. The second set of adhesive patches is adjacent to a top or bottom side of the label 400. The arrangement of the first and second sets define a large center area portion that is devoid of any adhesive and shaped similar to a rectangle having a concave half circle top and bottom and an elongated concave half circle right side and left side. Both the first set of adhesive patches and the second set of adhesive patches are of a similar shape; however, the second set of adhesive patches is longer and wider than the first set of adhesive patches. The similar shapes are of a half circle stretched out from top to bottom and from left to right. One side of each of the 4 adhesive patches is straight while an opposing side of each of the 4 adhesive patches is a half-circle extending or oriented towards a center of the label 400.

The coverage area, shape, size, orientation, and placement of the four adhesive patches within the pattern 420 of the adhesive patch are optimized to minimize contact with printer components when the roll of the labels 400 are fed through the printer. However, the coverage area, shape, size, orientation, and placement of the 4 adhesive patches within the pattern 420 of the adhesive patch for each dispensed label 400 from the printer maintains the adhesive bonding characteristics for the type of the adhesive used to still stick and adhered the label 400 to package materials, objects, and surfaces.

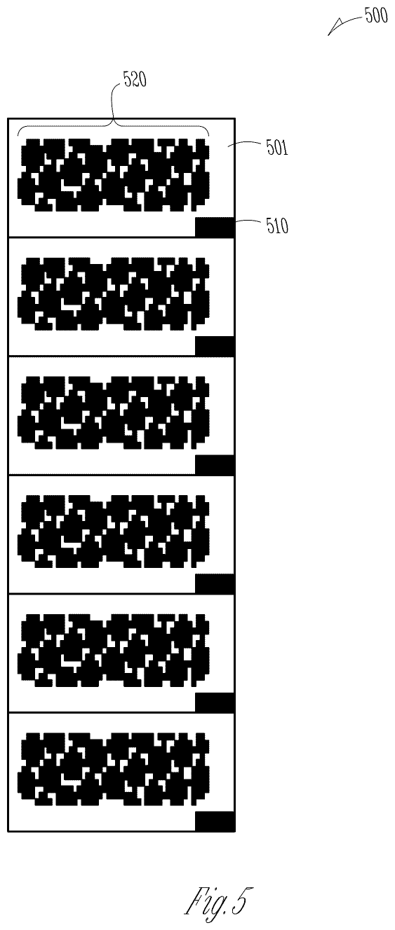

FIG. 5 is a diagram of a linerless label 500 in a roll, each label 500 includes an adhesive patch pattern 520, which is optimized for printer applications, according to an example embodiment. A backside 501 for each label 500 in the roll is illustrated in FIG. 5.

The backside 501 includes an adhesive patch illustrated by the darkened areas (except not 510), which are arranged in an adhesive patch pattern 520. Each label 500 within the roll further includes a printed/imaged sense mark 510, which is read by a printer to delineate and to identify each label 520 within the roll.

The adhesive patch pattern 520 includes a plurality of adhesive patches, which do not intersect with one another on the backside 501 of each label 500. Between each adhesive patch is an area, which is devoid of any adhesive. The adhesive patches are spaced and offset from the sides of the label 500 defining a perimeter along the backside 501 which is devoid of any adhesive. In an embodiment, each of the adhesive patches is in a same circular shape. In an embodiment, each of the adhesive patches is in a same bar or rectangular shape.

The coverage area, shape, size, orientation, and placement of the adhesive patches within the pattern 520 of the adhesive patch are optimized to minimize contact with printer components when the roll of the labels 500 are fed through the printer. However, the coverage area, shape, size, orientation, and placement of the adhesive patches within the pattern 520 of the adhesive patch for each dispensed label 500 from the printer maintains the adhesive bonding characteristics for the type of the adhesive used to still stick and adhered the label 500 to package materials, objects, and surfaces.

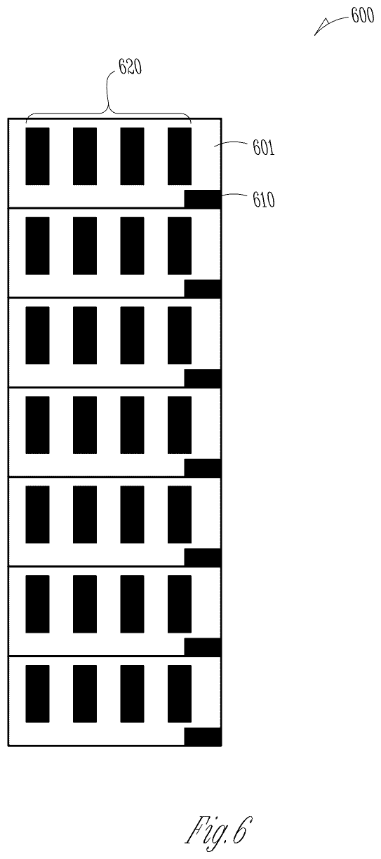

FIG. 6 is a diagram of another linerless label 600 in a roll, each label 600 includes an adhesive patch pattern 620, which is optimized for printer applications, according to an example embodiment. A backside 601 for each label 600 in the roll is illustrated in FIG. 6.

The backside 601 includes an adhesive patch illustrated by the darkened areas (except not 610), which are arranged in an adhesive patch pattern 620. Each label 600 within the roll further includes a printed/imaged sense mark 610, which is read by a printer to delineate and to identify each label 620 within the roll.

The adhesive patch pattern 620 includes 4 adhesive patches, which do not intersect with one another on the backside 601 of each label 600. Between each adhesive patch is an area, which is devoid of any adhesive. The adhesive patches are evenly spaced apart from one another along the backside 601 and each adhesive patch is offset from a top and a bottom of label 600. Each of the adhesive patches is of a rectangular bar shape that extends from an offset along a top of the label 600 to an offset along a bottom of the label 600. Two of the 4 adhesive patches are adjacent to a right side or left side of the label 600, and two of the 4 adhesive patches adjacent to a top of the label 600, a bottom of the label 600, and two other adhesive patches on a right and a left.

The coverage area, shape, size, orientation, and placement of the four adhesive patches within the pattern 620 of the adhesive patch are optimized to minimize contact with printer components when the roll of the labels 600 are fed through the printer. However, the coverage area, shape, size, orientation, and placement of the 4 adhesive patches within the pattern 620 of the adhesive patch for each dispensed label 600 from the printer maintains the adhesive bonding characteristics for the type of the adhesive used to still stick and adhered the label 600 to package materials, objects, and surfaces.

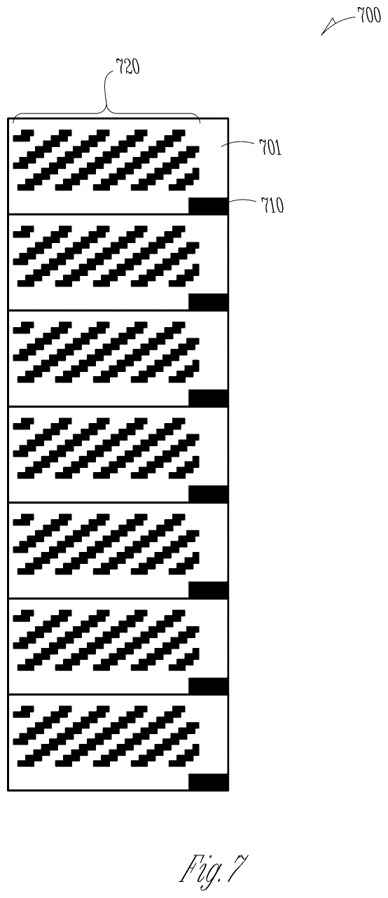

FIG. 7 is a diagram of a linerless label 700 in a roll, each label 700 includes an adhesive patch pattern 720, which is optimized for printer applications, according to an example embodiment. A backside 701 for each label 700 in the roll is illustrated in FIG. 7.

The backside 701 includes an adhesive patch illustrated by the darkened areas (except not 710), which are arranged in an adhesive patch pattern 720. Each label 700 within the roll further includes a printed/imaged sense mark 710, which is read by a printer to delineate and to identify each label 720 within the roll.

The adhesive patch pattern 720 includes 7 adhesive patches, which do not intersect with one another on the backside 701 of each label 700. Between each adhesive patch is an area, which is devoid of any adhesive. The adhesive patches are evenly spaced apart from one another along the backside 701 and diagonally disposed along the backside 701. The adhesive patches are offset from a top, a bottom, a right, and a left side of label 700. Each adhesive patch extends from a top right portion of the label to a bottom left portion of the label 700. Pairs of the adhesive patches are of a same size, whereas the sizes between different pairs are of varied sizes.

The coverage area, shape, size, orientation, and placement of the 7 adhesive patches within the pattern 720 of the adhesive patch are optimized to minimize contact with printer components when the roll of the labels 700 are fed through the printer. However, the coverage area, shape, size, orientation, and placement of the 7 adhesive patches within the pattern 720 of the adhesive patch for each dispensed label 700 from the printer maintains the adhesive bonding characteristics for the type of the adhesive used to still stick and adhered the label 700 to package materials, objects, and surfaces.

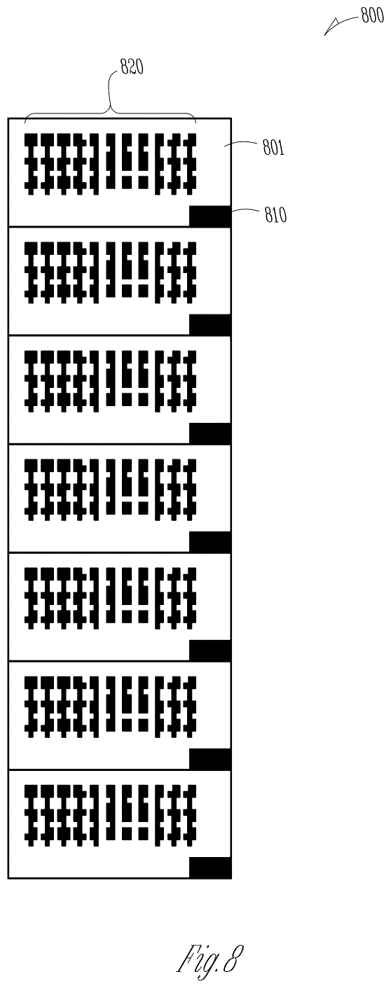

FIG. 8 is a diagram of yet another linerless label 800 in a roll, each label 800 includes an adhesive patch pattern 820, which is optimized for printer applications, according to an example embodiment. A backside 801 for each label 800 in the roll is illustrated in FIG. 8.

The backside 801 includes an adhesive patch illustrated by the darkened areas (except not 810), which are arranged in an adhesive patch pattern 820. Each label 800 within the roll further includes a printed/imaged sense mark 810, which is read by a printer to delineate and to identify each label 820 within the roll.

The adhesive patch pattern 820 includes three rows of adhesive patches, which do not intersect with one another on the backside 801 of each label 800. Between each adhesive patch is an area, which is devoid of any adhesive. The adhesive patches are evenly spaced apart from one another within their corresponding rows along the backside 801. The adhesive patches are offset from a top, a bottom, a right, and a left side of label 800. In an embodiment, each row includes 11 rectangle or bar shaped adhesive patches. In an embodiment, each row includes 5 or more rectangle or bar shaped adhesive patches. A first row of the adhesive patches is adjacent to a top, right, and left side of the label 800 and adjacent to a second row of the adhesive patches along a bottom. The second row of the adhesive patches is adjacent on a right to a right side of the label 800, adjacent on a left to a left side of the label 800, adjacent to the first row along a top, and adjacent to a third row of the adhesive patches along a bottom. The third row of adhesive patches is adjacent on a right to a right side of the label 800, adjacent on a left to left side of the label 800, adjacent to a bottom side of the label 800 along a bottom, and adjacent along a top to a bottom of the second row of adhesive patches. Each adhesive patch extends from a top right portion of the label to a bottom left portion of the label 800. Pairs of the adhesive patches are of a same size, whereas the sizes between different pairs are of varied sizes.

The coverage area, shape, size, orientation, and placement of the three rows adhesive patches within the pattern 820 of the adhesive patch are optimized to minimize contact with printer components when the roll of the labels 800 are fed through the printer. However, the coverage area, shape, size, orientation, and placement of the three rows of adhesive patches within the pattern 820 of the adhesive patch for each dispensed label 800 from the printer maintains the adhesive bonding characteristics for the type of the adhesive used to still stick and adhered the label 800 to package materials, objects, and surfaces.

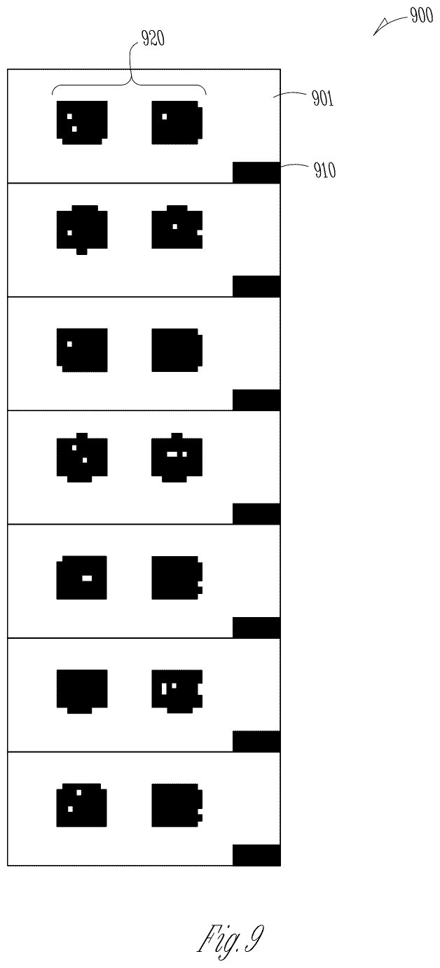

FIG. 9 is a diagram of a linerless label 900 in a roll, each label 900 includes an adhesive patch pattern 920, which is optimized for printer applications, according to an example embodiment. A backside 901 for each label 900 in the roll is illustrated in FIG. 9.

The backside 901 includes an adhesive patch illustrated by the darkened areas (except not 910), which are arranged in an adhesive patch pattern 920. Each label 900 within the roll further includes a printed/imaged sense mark 910, which is read by a printer to delineate and to identify each label 920 within the roll.

The adhesive patch pattern 920 includes two adhesive patches, which do not intersect with one another on the backside 901 of each label 900. Between each adhesive patch is an area, which is devoid of any adhesive. In an embodiment, the two adhesive patches are square shaped. Each adhesive patch is equally spaced from a top, a bottom, and a left or right side of the label 900. Furthermore, the two adhesive patches are equally spaced between one another, such that the two adhesive patches are substantially centered as a pair on the backside 901.

The coverage area, shape, size, orientation, and placement of the two adhesive patches within the pattern 920 of the adhesive patch are optimized to minimize contact with printer components when the roll of the labels 900 are fed through the printer. However, the coverage area, shape, size, orientation, and placement of the two adhesive patches within the pattern 920 of the adhesive patch for each dispensed label 900 from the printer maintains the adhesive bonding characteristics for the type of the adhesive used to still stick and adhered the label 900 to package materials, objects, and surfaces.

In an embodiment, the adhesive with a given adhesive patch is discontinuous. In an embodiment, the adhesive between the adhesive patches is discontinuous.

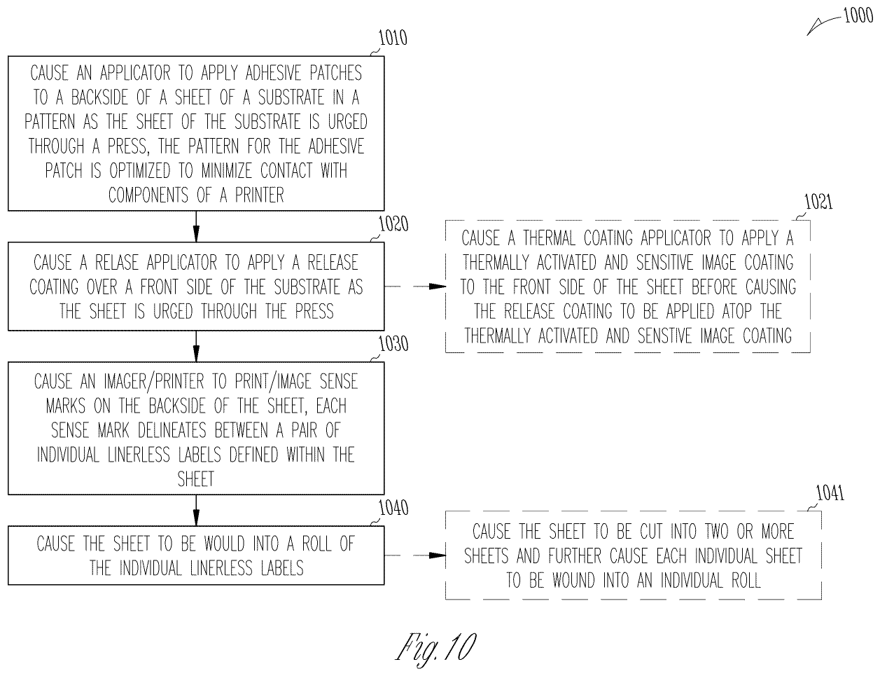

FIG. 10 is a diagram of a method 1000 for manufacturing a roll of linerless labels, each label with an adhesive patch pattern optimized for printer applications, according to an example embodiment. The method 1000 is implemented on a press through firmware that controls electromechanical components of the press to manufacture linerless labels 100, 200, 300, 400, 500, 600, 700, 800, and/or 900 on rolls, as described herein and above. A processor associated with the firmware/software executes instructions to perform the method 1000 and to control the electromechanical components of the press.

The press includes a variety of stations. Each station associated with manufacturing a specific component of the linerless labels 100, 200, 300, 400, 500, 600, 700, 800, and/or 900. The roll includes a web of a label substrate that passes through the stations and is wound into a roll of the labels. Each roll includes a plurality of instances of linerless labels defined within the corresponding roll. The processor executes the instructions of the firmware/software to cause the corresponding electromechanical components of a given station to add the corresponding specific component to the labels to the roll.

The specific components added to the labels at the stations include, by way of example only, applying an aggressive adhesive in optimized patch patterns to a backside of the substrate, applying a release coating to a front side of the substrate, applying a thermally activated print coating to the backside and/or front side of the substrate when the thermally activated print coating was not already present on the substrate, drying one or any of the coatings applied to the backside and/or front side of the substrate, cooling or curing one or any of the coatings applied to the backside and/or front side of the substrate, printing sense marks 110, 120, 130, 140, 150, 160, 170, 180, 190 when the sense marks were not already pre-printed on the label substrate, a cutting station that cuts the web into sheets, a rolling stations that rolls each sheet into a roll, etc.

An adhesive application station includes a variety of electromechanical components controlled by the processor via the corresponding instructions of the firmware/software. The electromechanical components include an applicator controlled by the processor to apply an adhesive patch in any of the above-noted adhesive patch patterns 120, 220, 320, 420, 520, 620, 720, 820, and/or 920. In an embodiment, the electromechanical components of the applicator include a single hot melt module, or a plurality of hot melt modules arranged in an array or a grid. In an embodiment, the electromechanical components of the applicator include a stamp wheel, or a plurality of stamp wheels arranged in a single line or a plurality of lines. In an embodiment, the electromechanical components of the applicator include a single gravure printing cylinder and/or a single rotary flatbed screen and/or a single flexographic cylinder. In an embodiment, the electromechanical components of the applicator include a plurality of gravure printing cylinders and/or plurality of rotary flatbed screens and/or a plurality of flexographic cylinders arranged in a plurality of rows.

At 1010, the processor of the press causes the applicator to apply adhesive patches in an adhesive pattern 120, 220, 320, 420, 520, 620, 720, 820, and/or 920 on a backside of a sheet of a label substrate as the sheet of the substrate is being urged through the press. In an embodiment, the adhesive is an aggressive adhesive. The adhesive pattern of the patch is optimized to minimize the adhesive coverage area of the patch and to ensure or to minimize adhesive contact with components of a printer. The adhesive patch is applied via an applicator or a corresponding station of the press.

At 1020, the processor of the press causes a release applicator to apply a release coating over a front side of the label substrate as the sheet is urged through the stations of the press. In an embodiment, at 1021, the press causes a thermal coating applicator to apply a thermally activated and sensitive image coating to the front side of the label substrate before causing the release coating to be applied atop the thermally activated and sensitive image coating.

At 1030, the processor of the press causes an imager/printer to print/image sense marks on the backside of sheet. Each sense mark delineates between a pair of individual linerless labels defined within the sheet. At 1040, the processor of the press causes the sheet to be would into a roll. In an embodiment, at 1041, the processor causes the sheet to be cut into two or more sheets and thereafter causes each individual sheet to be wound into a roll. In an embodiment, the roll or the individual rolls are linerless label rolls, each roll includes a plurality of linerless labels defined within the corresponding roll by the sense marks and each linerless label include a single adhesive patch with the adhesive disposed on the corresponding backside in the optimized pattern 120, 220, 320, 420, 520, 620, 720, 820, and/or 920.

Although the present invention is described with reference to certain preferred embodiments thereof, variations and modifications of the present invention can be affected within the spirit and scope of the following claims.

1. A label, comprising:
a substrate; and
an adhesive patch disposed on a backside of the substrate, wherein the adhesive patch disposed in a pattern of an adhesive on the backside, wherein the pattern is optimized to minimize adhesive coverage on the backside and minimize adhesive contact with components of a printer when the label is fed through the printer;
wherein an adhesive coverage area of the adhesive patch is less than a remaining area of the backside;
wherein the adhesive patch is disposed in a pattern that maintains adhesive bonding characteristics when the label is dispensed from the printer.

2. The label of claim 1, wherein the adhesive patch includes four adhesive patches arranged in the pattern on the backside.

3. The label of claim 2, wherein a first adhesive patch and a second adhesive patch is of a first shape, and a third adhesive patch and a fourth adhesive patch is of a second shape.

4. The label of claim 3, wherein the pattern includes the first adhesive patch diagonal to the second adhesive patch on the backside, and the third adhesive patch diagonal to the fourth adhesive patch on the backside.

5. The label of claim 4, wherein the pattern includes the first adhesive patch above the third adhesive patch on the backside, and the fourth adhesive patch above the second adhesive patch on the backside.

6. The label of claim 5, wherein the first adhesive patch and the second adhesive patch include diagonal cutout bars that are devoid of any of the adhesive.

7. The label of claim 1, wherein a coverage area of the adhesive within the adhesive patch is approximately 30.10% or 36% of a total coverage area for the backside.

8. The label of claim 1, wherein the adhesive is a high tack or an aggressive adhesive.

9. The label of claim 1, wherein the adhesive patch includes two or more adhesive patches arranged in the pattern on the backside, wherein the two or more adhesive patches are separated by areas of the backside that are devoid of any of the adhesive and the two or more adhesive patches do not intersect on the backside.

10. The label of claim 1, wherein the adhesive patch includes two or four adhesive patches arranged in the pattern, each adhesive patch having a rectangle, square, or bar shape, each adhesive patch separated by areas of the backside that are devoid of any the adhesive and each of the adhesive patches do not intersect with another one of the adhesive patches on the backside.

11. The label of claim 1, wherein the adhesive patch includes three rows of adhesive patches arranged in the pattern, each adhesive patch in each row separated by an area of the backside that is devoid of any of the adhesive.

12. The label of claim 1, wherein the adhesive patch includes a plurality of adhesive patches arranged in the pattern, each adhesive patch is of a rectangle or bar shape, each adhesive patch separated by an area of the backside that is devoid of any adhesive, and the adhesive patches diagonally disposed within the pattern on the backside.

13. A roll of labels, comprising:
a substrate; and
adhesive patches disposed on a backside in a pattern, wherein each label is defined by one of the adhesive patches and identified by a sense mark disposed on the backside of the substrate under a corresponding patch;
wherein the pattern minimizes a coverage area of an adhesive associated with the adhesive patches and minimizes adhesive contact with components of a printer when the roll is fed through the printer;
wherein the adhesive patches are offset from sides of each label defining a perimeter along the backside that is devoid of any adhesive;
wherein the pattern maintains adhesive bonding characteristics when individual labels are dispensed from the printer.

14. The roll of claim 13, wherein each adhesive patch includes two or more adhesive patches arranged the pattern on the backside.

15. The roll of claim 14, wherein the two or more adhesive patches are rectangular in shape, square in shape, or bar shaped.

16. The roll of claim 15, wherein each of the two or more adhesive patches arranged in the pattern on the backside do not intersect and are separated by areas on the backside that are devoid of any of the adhesive.

17.-20. (canceled)
